(19) United States
(12) Patent Application Publication
(10) Pub. No.: US 2008/0244444 A1
(43) Pub. Date: Oct. 2, 2008

(54) CONTEXTUAL COMPUTER WORKSPACE

(75) Inventors: Thomas R. Bauman, Redmond, WA (US); Michael Pierce Goncalves, Bellevue, WA (US); Todd Haugen, Clyde Hill, WA (US); Kristofer Duncan Hoffman, Sammamish, WA (US); John Eugene Knapp, Seattle, WA (US); Robert Levy, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/694,252

(22) Filed: Mar. 30, 2007

(51) Int. Cl. G06F 3/048

(52) U.S. Cl. 715/806

(57) ABSTRACT

A contextual computer workspace feature provides users with a mechanism to capture and output a state of a contextual computer workspace so that the user may continue working on a computer-based task as though no interruptions occurred. A state of a contextual computer workspace, including the window views and content thereof, is captured. Upon capturing a state of a contextual computer workspace, an indication to access the contextual computer workspace is received. The state of the contextual computer workspace is restored and the restored state is then output to communicate the contextual computer workspace to the user.

### BACKGROUND

Computer-based tasks generally involve having one or more windows available to a user. The user may view the windows and interact with the windows, or content thereof, associated with the computer-based task. Often, a user may not complete a computer-based task due to various interruptions and will continue the task at a later time. For example, in some instances, a user may need to interrupt an original task to begin work on an unrelated task. In other instances, due to the length of a computer-based task, a user may be unable to complete a computer-based task in one computer session.

Notwithstanding the reason for an interruption, the user will return to the original task at a later time. Each time a user returns to the original task, the user will exert time and effort to attain the state of the displayed windows prior to the interruption. For example, to return to the state of an original task, the user may be required to recollect the specifics of the computer-based task, the pertinent files, and the location of the pertinent files. In addition, the user may need to resize and rearrange the windows such that the state of the displayed windows appears as though an interruption did not occur.

In such cases, a user may wish to quickly return to the state of the displayed windows prior to the interruption. However, there is currently no simple and convenient way for a user to efficiently continue a computer-based task as though an interruption did not occur. A product that would quickly restore the state of windows and contents thereof would increase user productivity and satisfaction.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments are related to capturing and outputting a state of a contextual computer workspace so that a user may continue working on a computer-based task as though no interruptions occurred. In an embodiment, a state of a contextual computer workspace is captured. Upon capturing a state of a contextual computer workspace, an indication to access the contextual computer workspace is received. The state of the contextual computer workspace is restored and the restored state is then output to communicate the contextual computer workspace to the user.

### BRIEF DESCRIPTION OF THE DRAWINGS

Embodiments are described in detail below with reference to the attached drawing figures, wherein:

FIG. 1 is a block diagram of a computing-system environment for use in implementing an embodiment;

FIG. 2 is a block diagram of a computing system architecture for use in implementing an embodiment;

FIG. 3 is a block diagram of an exemplary computer system for use in implementing an embodiment;

FIG. 4 is a flow diagram illustrating an exemplary method for capturing and outputting a state of a contextual computer workspace;

FIG. 5 is an exemplary screen display showing an example of the beginning of a contextual computer workspace;

FIG. 6 is an exemplary screen display showing an example of a first state of a contextual computer workspace;

FIG. 7 is an exemplary screen display showing an example of a restored contextual computer workspace having a state substantially similar to the first state of the contextual computer workspace;

FIG. 8 is an exemplary screen display showing an example of an addition to the restored state of the contextual computer workspace; and

FIG. 9 is an exemplary screen display showing an example of a second state of the contextual computer workspace.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As previously mentioned, upon an interruption, current computer users may not efficiently return to a computer-based task and continue working where the user left off prior to the interruption. In particular, to return to a computer-based task as though no interruption occurred, the user must attain the state of the displayed windows prior to the interruption. In such cases, the user may be required to locate and open pertinent files as well as resize and rearrange the open window views. This approach for computer users, however, is time consuming. As a result, computer users may be less efficient and unsatisfied.

Embodiments hereinafter discussed relate to capturing and outputting a state of a contextual computer workspace. In particular, embodiments allow, among other things, capturing a state of a contextual computer workspace and, at a later time, restoring the state of the contextual computer workspace so that a user may continue working on a computer-based task as though no interruption occurred. Instead of requiring users to return to the state of the original task by reopening the pertinent files and arranging the open windowview on the display monitor, embodiments hereinafter discussed provide a simple and efficient manner for capturing and outputting a state of a contextual computer workspace.

As used herein, the term “computer-based task” is used to refer to any task being performed, at least in part, with the assistance of a computer. For example, a user may have a computer-based task of planning a trip and, accordingly, may utilize a computer to prepare a packing list, create an itinerary, and prepare a list of places to visit. Additionally, as used herein, the term “contextual computer workspace” is used to refer to a computer-based task having one or more window views available to a user for viewing and modifying. For example, a user planning a trip may have a “Trip” contextual computer workspace that includes a window view of a packing list, a window view of an itinerary, and a window view of a list of places to visit. Although the one or more window views of a contextual computer workspace will generally relate to one another, it is not imperative for a contextual computer workspace to only include related window views.

As used herein, the term “window view” is used to refer to a visual area that may be displayed and manipulated on a computer desktop. Accordingly, an open window view may be a displayed or minimized window view that may be resized, moved, hidden, restored, and closed by a user. Further, a user may generally modify the content contained within an open window view. By contrast, a closed window view is not displayed or minimized on a computer desktop but is capable of being displayed on a computer desktop and, thereafter, being manipulated. In one embodiment, window views may exist within a contextual computer workspace. In such an embodiment, a window view may be accessed upon opening the corresponding contextual computer workspace. In another embodiment, window views may exist separate from the contextual computer workspace. As such, a window view may be accessed whether or not the corresponding contextual computer workspace is open.

A “state of a contextual computer workspace,” as used herein, refers to a unique configuration of information in a contextual computer workspace. For example, a “Trip” contextual computer workspace may have a state including precise content and arrangement of a packing list window view, an itinerary window view, and a list of places to visit window view. Each time a user manipulates a window view of a contextual computer workspace, or the content thereof, a new state of the contextual computer workspace exists. Accordingly, a contextual computer workspace may have multiple states.

As used herein, the term “contextual computer workspace feature” is used to refer to a feature that captures and outputs a state of a contextual computer workspace. The contextual computer workspace feature may reside within an application, a web-based application, or an operating system executing on a client-computing device or a server. In one embodiment, a contextual computer workspace feature may include storing, either manually or automatically, multiple states of a contextual computer workspace such that a user may select the specific state the user desires to view and manipulate. One skilled in the art will appreciate that in such an embodiment, a user may select the contextual computer workspace desired, and the most recent state of the contextual computer workspace may be displayed. In another embodiment, a contextual computer workspace feature may only store the more recent state of a contextual computer workspace such that a user, when selecting to view and manipulate a specific contextual computer workspace, will be presented with the most recent state of the contextual computer workspace.

The contextual computer workspace feature provides users with a mechanism to easily switch between various computer-based tasks the user may be utilizing. For example, in one embodiment, multiple contextual computer workspaces may be stored in a database and a user may select, via a graphical user interface, the contextual computer workspace the user would like to view and manipulate. By way of example only, within one contextual computer workspace, a user may be planning a trip to Paris and, accordingly, window views pertaining to the Paris trip may be displayed and manipulated upon the selection of the “Paris Trip” contextual computer workspace. The user may desire to discontinue working on the “Paris Trip” contextual computer workspace and continue planning a trip to the Oregon coast. In such a case, the user may simply select the “Oregon Coast” contextual computer workspace, and the windows pertaining to the Oregon coast trip may are then displayed and may be manipulated.

In one aspect, an embodiment is directed to a method for capturing and outputting a state of a contextual computer workspace in a computer system having a graphical user interface including a display and a user interface selection device. The method includes receiving an indication to capture a state of a contextual computer workspace at a first instance, wherein the contextual computer workspace comprises one or more window views. The method also includes identifying one or more window views to capture in the state of the contextual computer workspace and retrieving information pertaining to the identified window views. The method further includes storing the retrieved information to capture the state of the contextual computer workspace. The method still further includes receiving, at a second instance, an indication to output the contextual computer workspace having the state of the contextual computer workspace at the first instance; and outputting the contextual computer workspace having the state of the contextual computer workspace at the first instance, wherein a user may view and interact with the contextual computer workspace.

In another aspect, an embodiment is directed to method in a computer system for outputting a state of a contextual computer workspace. The method includes storing information retrieved from one or more window views having a first state of a contextual computer workspace, wherein the contextual computer workspace comprises one or more window views. The method also includes receiving an indication to access the contextual computer workspace. The method further includes outputting the contextual computer workspace having a restored state that is substantially similar to the first state of the contextual computer workspace.

In a further aspect, an embodiment is directed to a computer system for capturing a first state of a contextual computer workspace. The computer system includes an identifying component to identify at least one open window view. The computer system also includes a retrieving component to retrieve information pertaining to one or more of the at least one open window view identified by identifying component. The computer system further includes a storing component to store the information retrieved by the retrieving component.

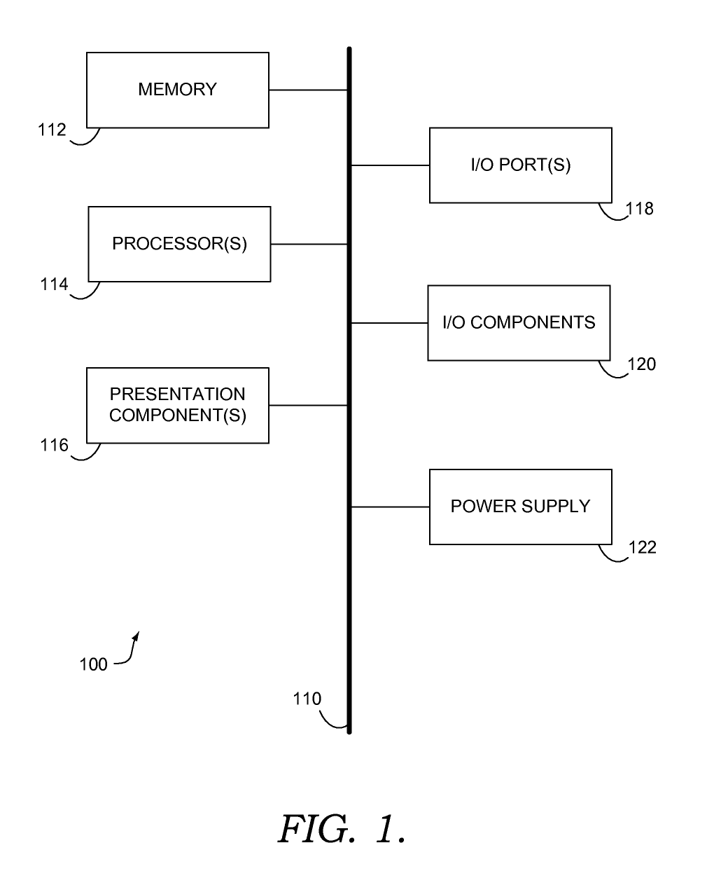

Having briefly described an overview of the present invention, an exemplary operating environment in which various aspects of the present invention may be implemented is described below in order to provide a general context for various aspects of the present invention. Referring initially to FIG. 1, an exemplary operating environment for implementing embodiments is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

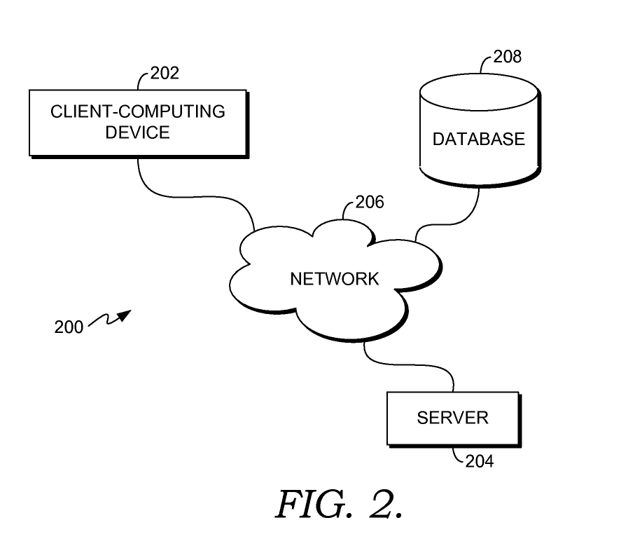

As previously set forth, embodiments of the present invention relate to computing systems for capturing a state of a contextual computer workspace and outputting such a state to at least one user. With reference to FIG. 2, a block diagram is illustrated that shows a computing system architecture for use in implementing an embodiment of the present invention. The computing system architecture, generally referenced by numeral 200, comprises a client-computing device 202, a server 204, and a database 208 which communicate via a network 206. It will be appreciated by one of ordinary skill in the art that computing system architecture 200 is merely an example of one suitable computing system environment and is not intended to suggest any limitation as to the scope of use or functionality of the present invention. Neither should computing system architecture 200 be interpreted as having any dependency or requirement related to any single component or combination of components illustrated therein.

The client-computing device 202 may be any type of computing device, such as device 100 described above with reference to FIG. 1. By way of example only and not limitation, the client-computing device 202 may be a personal computer, desktop computer, laptop computer, handheld device, cellular phone, digital phone, PDA, or the like. It should be noted that the invention is not limited to implementation on such computing devices, but may be implemented on any of a variety of different types of computing devices.

Network 206 may include any computer network or combination thereof. Examples of computer networks configurable to operate as network 206 include, without limitation, a wireless network, landline, cable line, fiber-optic line, LAN, WAN, peer-to-peer, or the like. Network 206 is not limited, however, to connections coupling separate computer units. Rather, network 206 may also comprise subsystems that transfer data between servers or computing devices. For example, network 206 may also include a point-to-point connection, tan internal system Ethernet, a backplane bus, an electrical bus, a neural network, or other internal system. In an embodiment where network 206 comprises a LAN networking environment, components are connected to the LAN through a network interface or adapter. In an embodiment where network 206 comprises a WAN networking environment, components use a modem, or other means for establishing communications over the WAN, to communicate. In embodiments where network 206 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The server 204 may include any type of application server, database server, or file server configurable to perform the methods described herein. In addition, the server 204 may be a dedicated or shared server. One example, without limitation, of a server that is configurable to operate as the server 204 is a structured query language (“SQL”) server executing server software such as SQL Server 2005, which was developed by the Microsoft® Corporation headquartered in Redmond, Wash.

Components of server 204 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via network 206. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 204 is illustrated as a single box, one skilled in the art will appreciate that the server 204 is scalable. For example, the server 204 may in actuality include 100 servers in communication. Alternatively, the computing system architecture of FIG. 2 may operate without a server such as, for example, in a LAN or peer-to-peer network. Moreover, the database 208 may be included within the server 204 or client-computing device 202 as a computer-storage medium. Further, in accordance with an embodiment of the present invention, the computing system architecture of FIG. 2 may operate without the server 204 and the network 206. In such an embodiment, the contextual computer workspace feature resides on the client-computing device 202. The single unit depictions are meant for clarity, not to limit the scope of embodiments in any form.

In operation, a user interacts with the client-computing device 202 via a graphical user interface. In one embodiment, the graphical user interface accesses the contextual computer workspace feature via an application or operating system executing on the client-computing device 202 or the server 204. In alternative embodiments, the graphical user interface utilizes a web browser to access a web-based application having the contextual computer workspace feature executing on the server 204.

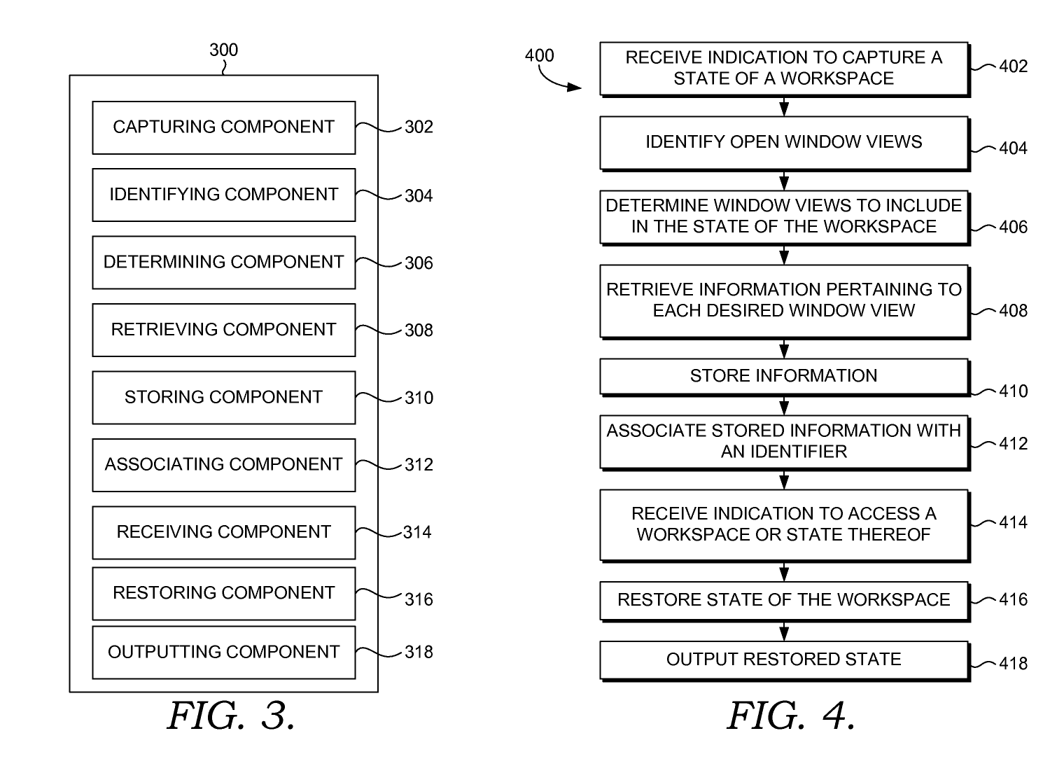

FIG. 3 illustrates an exemplary computer system for providing a contextual computer workspace feature that captures and outputs states of contextual computer workspaces. As shown in FIG. 3, an exemplary computer system 300 includes a capturing component 302, an identifying component 304, a determining component 306, a retrieving component 308, a storing component 310, an associating component 312, a receiving component 314, a restoring component 316, and an outputting component 318. Computer system 300 may be included, for instance, within an application, web-based application, or operating system executing on a client-computing device 202, a server 204, or a combination thereof. While capturing component 302, identifying component 304, determining component 306, retrieving component 308, storing component 310, associating component 312, receiving component 314, restoring component 316, and outputting component 318 are illustrated as separate components in FIG. 3, one skilled in the art will appreciate that the components are scalable and may, in actuality, be combined into a single component or a plurality of components.

Capturing component 302 is a component that receives an indication to capture a state of a contextual computer workspace. In some embodiments, capturing component 302 receives an indication to capture the current state of a contextual computer workspace. An indication to capture a state of a contextual computer workspace may be provided by a user. For example, a user working on a computer-based task may select to create a new contextual computer workspace or select a “save” button for a new or an existing contextual computer workspace.

Alternatively, an indication to capture a state of a contextual computer workspace may be automatically provided based on a user's actions. For example, a user's action in selecting another contextual computer workspace or modifying the contextual computer workspace as well as exiting or logging off an application, operating system, or web service having a contextual computer workspace feature may result in capturing component 302 receiving an indication to capture a state of a contextual computer workspace. In instances where the user selects another contextual computer workspace, a workspace selection tool may be utilized by a user to select a contextual computer workspace to view. A workspace selection tool may include a list of workspace names, tabs of workspaces, icons indicating workspaces, thumbnails displaying workspace images, or the like. The workspace selection tool may be positioned in a vertical alignment on the side of the contextual computer workspace, in a horizontal alignment on the bottom or top of the workspace, or any other position within the monitor display. The workspace selection tool may be provided by a tooling component and may be output by outputting component 318.

An indication to capture a state of a contextual computer workspace may also be provided automatically based on a specific time. In such cases, the specific time may be specified by a user, specified by a developer or provider of the contextual computer workspace feature, or determined by an algorithm. For example, an indication to capture a state of a contextual computer workspace may be automatically provided every five minutes.

Identifying component 304 identifies the window views open at the time capturing component 302 receives an indication to capture a state of a contextual computer workspace. Open window views may include window views displayed on the display monitor as well as minimized window views. As previously mentioned, the open window view and the content thereof may be viewed and modified. In some embodiments, identifying component 304 may only identify window views displayed on the display monitor. In other embodiments, identifying component 304 may identify open window views displayed on the display monitor as well as minimized window views.

Determining component 306 determines which window views identified by identifying component 304 to include when capturing a state of a contextual computer workspace. In some embodiments, all window views identified by identifying component 304 may be included in a state of a contextual computer workspace. In other embodiments, general window views may be excluded from a state of a contextual computer workspace, e.g., a workspace selection tool, buttons or icons that provide functionality, and the like. Alternatively, a user or contextual computer workspace feature developer or provider may specify particular window views to exclude from a state of a contextual computer workspace.

For each window view determined to be included in a state of a contextual computer workspace, retrieving component 308 retrieves information pertaining to each desired window view. The retrieving component may retrieve, for example, the location of the window view, the position of the window view, the size of the window view, the vertical order, the specific state of each window view, and the like. The size of the window view may be a percentage of the screen resolution so that in instances where a user changes the computer's screen resolution or uses another computing device having a varied screen resolution, the window views are displayed proportionately to the screen resolution. In such an embodiment, the window view location is not an absolute pixel location.

Storing component 310 stores the information retrieved by retrieving component 308 in a database, such as database 208, or like storage device. In one embodiment, storing component 310 may store multiple states for each contextual computer workspace. In another embodiment, storing component 310 may only store the most recent state for each contextual computer workspace.

Associating component 312 associates an identifier with a contextual computer workspace or, in some embodiments, a state of a contextual computer workspace. An identifier may be text, a value, an icon, a sound, a thumbnail, or the like. Identifiers may be created by a user. For example, a user may name a contextual computer workspace “Family Vacation 2007” such that a user may thereafter select a “Family Vacation 2007” button to access the contextual computer workspace. Alternatively, the computer system may automatically create an identifier. For example, the computer may create a thumbnail displaying a state of a contextual computer workspace such that a user may thereafter select the thumbnail to access the state of the contextual computer workspace. Identifiers may be provided within a workspace selection tool such that a user may select the identifier pertaining to the desired contextual computer workspace or state thereof the user wishes to view.

Receiving component 314 receives an indication to access a specific contextual computer workspace or, in instances where multiple states of a contextual computer workspace are available to a user, a specific state of a contextual computer workspace. A user may select a specific contextual computer workspace or a state thereof via, for example, a workspace selection tool or other selection tool such as a drop down menu. In addition, a specific contextual computer workspace or a specific state of a contextual computer workspace may be selected automatically based on a user's action, e.g., opening an application, logging in to the computer. For example, an application, upon opening, may immediately display the most recent state of a contextual computer workspace such as the state of the contextual computer workspace displayed when a user last exited an application having a contextual computer workspace feature.

Restoring component 316 restores the state of the contextual computer workspace so that the state of the displayed contextual computer workspace will be substantially similar to a previous state of the contextual computer workspace. Restoring component 316 restores the state of a contextual computer workspace by utilizing the information retrieved by retrieving component 308 and stored by storing component 310.

Outputting component 318 outputs the state of the contextual computer workspace restored by restoring component 316. The state of the contextual computer workspace that is output is substantially similar to the immediately preceding state of the contextual computer workspace or one of multiple previous captured states of the contextual computer workspace. As such, the window views and the content of each window view may be displayed as though no interruption occurred. Upon display of the contextual computer workspace, a user may view and modify the output. For example, if desired, a user may rearrange the open window views, modify content within an open window view, or select to open a window view that is closed and, thereafter, modify the newly opened window or contents thereof.

In instances where a user selects to open a window view within a contextual computer workspace, such as a list, that was an open window view in a previous state, the window view may open having a substantially similar window view state as it previously had. For example, suppose a user has captured a first state of a “Trip” contextual computer workspace including a packing list window view, a list of things to do window view, and an itinerary window view, and the user chooses to close the packing list window view prior to capturing a second state of the contextual computer workspace. At a later time, the user views the captured second state of the contextual computer workspace, which includes only the list of things to do window view and the itinerary window view. If the user selects to open the packing list window view within the contextual computer workspace, the packing list window view may be displayed as it was captured in the first state. Accordingly, in such a case, upon opening the packing list, the window view may, for example, return to the same proximate location, having the same window view size, and having the same content.

In one embodiment, the output may include an advertisement. In such an embodiment, the advertisement may pertain to the computer-based task. In one instance, the advertisement may be a contextual advertisement in that the advertisement displayed is selected based on the content displayed or requested by the user. The same advertisement may appear each time the contextual computer workspace, or state thereof, is accessed. Alternatively, a different advertisement related to the contextual computer workspace may appear each time the contextual computer workspace is accessed, e.g., another advertisement from the same organization or another advertisement from a different organization in the same industry. In another instance, any advertisement, whether related or not to the contextual computer workspace, may be randomly selected to appear each time the contextual computer workspace is accessed.

Turning now to FIG. 4, a flow diagram is provided illustrating an exemplary method 400 for capturing and restoring a state of a contextual computer workstation, in accordance with one embodiment. As shown at block 402, an indication to capture a state of a contextual computer workspace is received. The state of the contextual computer workspace to be captured may have one open window view or multiple open window views. As previously mentioned, the indication to capture a state of a contextual computer workspace may be provided, for instance, by a user or automatically based on a user's actions or a specific time.

At block 404, window views open in the contextual computer workspace are identified. Open window views may include windows views displayed on the display monitor and minimized window views. At block 406, it is determined which of the windows identified at block 404 should be included in the state of the contextual computer workspace. In one embodiment, all window views, with the exception of general window views such as a workspace selection tool, may be included in the state of the contextual computer workspace. Information pertaining to each window view identified at block 406 is retrieved at block 408. The information retrieved at block 408 may include, for example, the location of the window view, the position of the window view, the size of the window view, the vertical order, the specific state of each window view, and the like.

At block 410, the information retrieved at block 408 is stored in a database or like storage device. The information stored for the current state at block 410 may be stored with other states of the contextual computer workspace or, alternatively, may replace the previously stored state of the contextual computer workspace. The information stored at block 410 is associated with an identifier at block 412. The identifier may, in one instance, provide a user with a mechanism to identify a specific contextual computer workspace or a specific state of a contextual computer workspace the user desires to access.

At block 414, an indication to access a specific contextual computer workspace or a specific state of a contextual computer workspace is received. Upon receiving an indication to access a specific contextual computer workspace or a specific state of a contextual computer workspace, a state of the contextual computer workspace is restored at block 416. In instances where a contextual computer workspace is specified, the most recent state, for example, of the contextual computer workspace may be restored. In instances where a state of a contextual computer workspace is specified, the particular state of the contextual computer workspace may be restored. At block 418, the restored state of the contextual computer workspace is output. A user may then view and modify the output where the user left off the last time the contextual computer workspace was accessed.

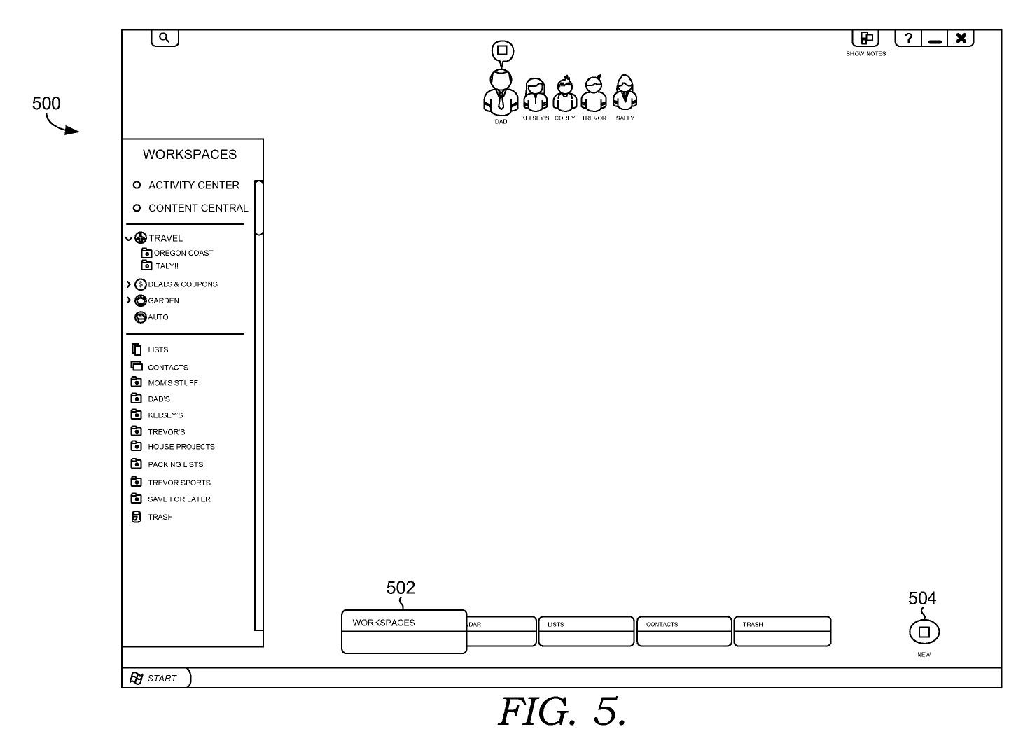

FIGS. 5-9 illustrate exemplary displays of graphical user interfaces for capturing and outputting a state of a contextual computer workspace, according to embodiments of the present invention. As previously mentioned, a contextual computer workspace may be any computer-based task having one or more window views available to a user for viewing and modifying. A state of a contextual computer workspace described herein may be displayed on client-computing device 202. A user of an application, web-based application, or an operating system having a contextual computer workspace feature can interact with the displayed contextual computer workspace using well known input components-such as, for example, a mouse, joystick, stylus, touch screen, keyboard, or the like.

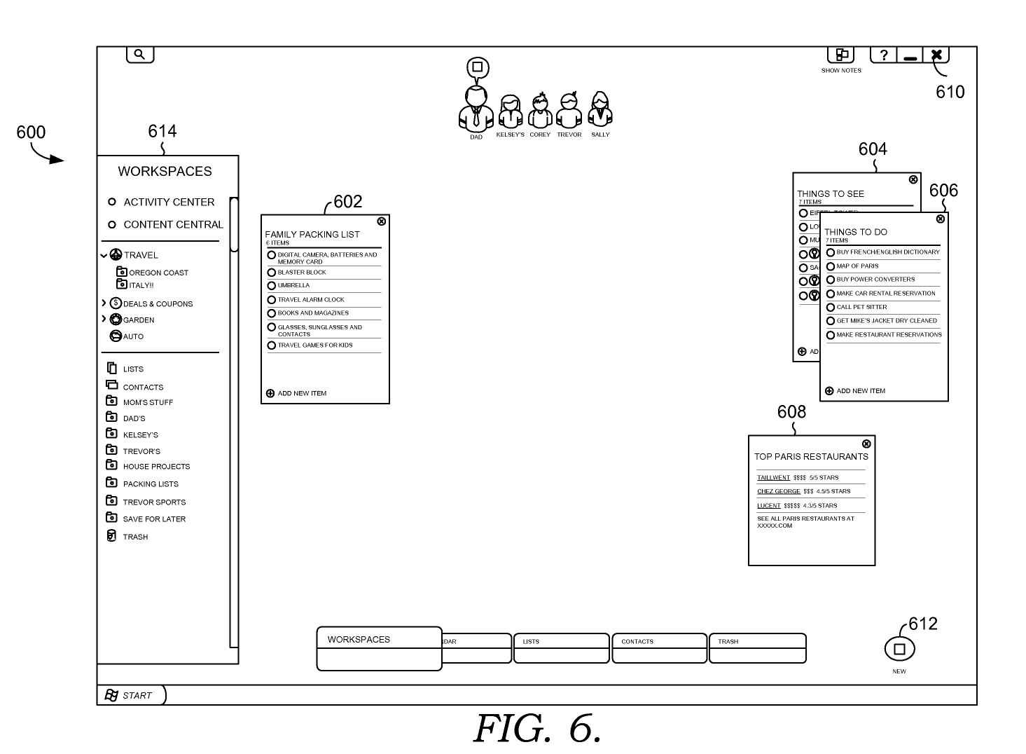

By way of illustration only, the exemplary displays of FIGS. 5-9 show views of a contextual computer workspace pertaining to planning a family trip to Paris. Suppose, for instance, that Dad begins planning a family trip to Paris. As shown in FIG. 5, Dad may begin a new contextual computer workspace 500 by selecting the “Workspaces” tab 502 and, subsequently, selecting the “New” icon 504. Upon selecting to begin a new contextual workspace 500, Dad may begin, via tools for adding windows and content thereof, a Family Packing List window view 602, a list of Things to See window view 604, a list of Things to Do window view 606, and a list of Top Paris Restaurants window view 608 as illustrated by contextual computer workspace 600 of FIG. 6.

Dad is unable to finish planning the family trip and desires to continue planning the trip at a later time. As such, Dad may choose to close the contextual computer workspace 600 by selecting the close button 610. Upon selecting the close button 610, an indication to capture a state of the contextual computer workspace is received by the computer system. Windows open in the contextual computer workspace 600 are then identified, i.e., window views 602, 604, 606, 608 as well as window view 614 among others. Thereafter, the computer system may determine that window views 602, 604, 606, and 608 are desired to be included in the first state of the contextual computer workspace. By contrast, window view 614, among others, may be determined to be excluded from the first state of the contextual computer workspace due to its general applicability. Information pertaining to window views 602, 604, 606, and 608 is retrieved and stored in a database. In one embodiment, upon selecting close button 610, Dad may be given the opportunity to associate an identifier with the contextual computer workspace. Accordingly, upon selecting close button 610, but prior to the application closing, Dad titles the contextual computer workspace “Paris 2007.” In an alternative embodiment, Dad may have created the window views 602, 604, 606, and 608 and then selected the “New” icon 612 to capture the contextual computer workspace and associate an identifier with the contextual computer workspace.

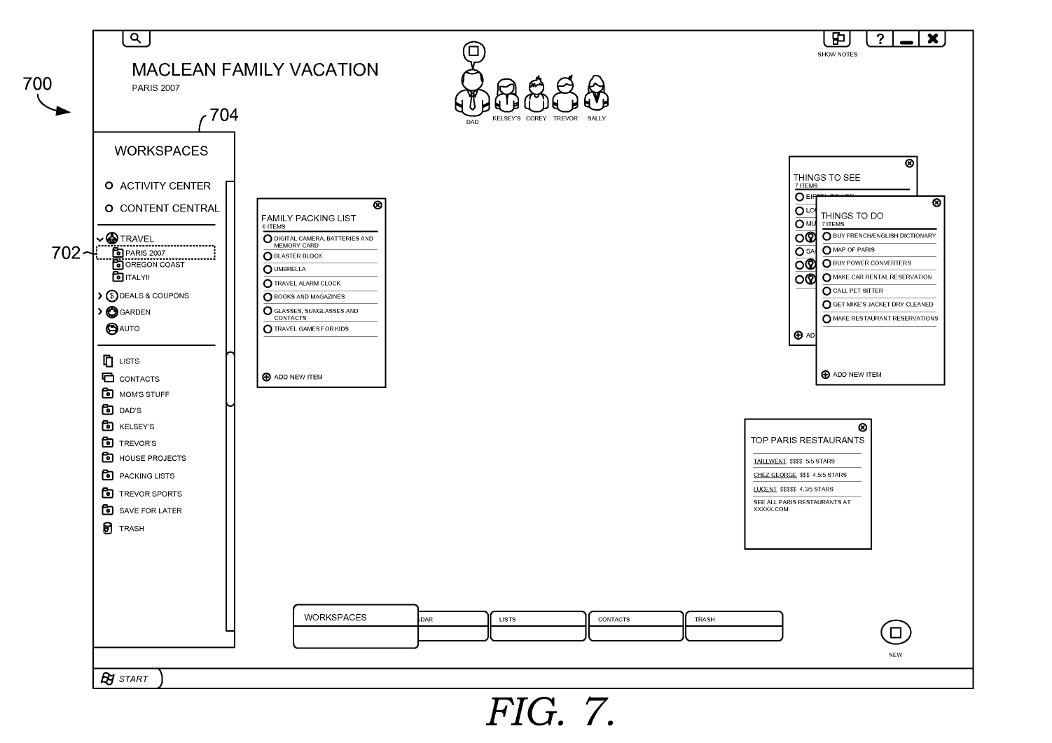

Suppose that, at a later instance, Dad selects the “Paris 2007” contextual computer workspace 702 listed within the workspace selection tool 704 of contextual computer workspace 700 of FIG. 7. The first state of the contextual computer workspace 600 captured in FIG. 6 is restored and output such that Dad may view and modify the “Paris 2007” contextual computer workspace, as displayed by “Paris 2007” contextual computer workspace 700 in FIG. 7. As shown, the first state of contextual computer workspace 600 captured in FIG. 6 is substantially similar to the restored and displayed “Paris 2007” contextual computer workspace 700 of FIG. 7. Although general open window views, such as window view 614 of FIG. 6, were not captured in the first state of contextual computer workspace 600, the window views may appear in the restored “Paris 2007” contextual computer workspace 700 as general window views.

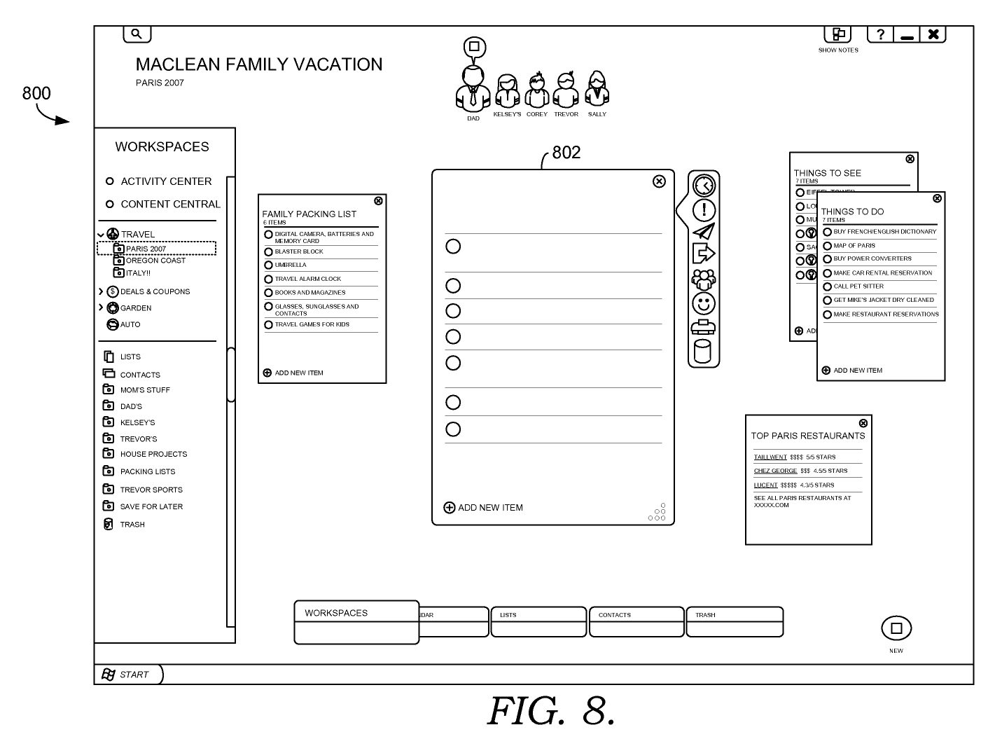

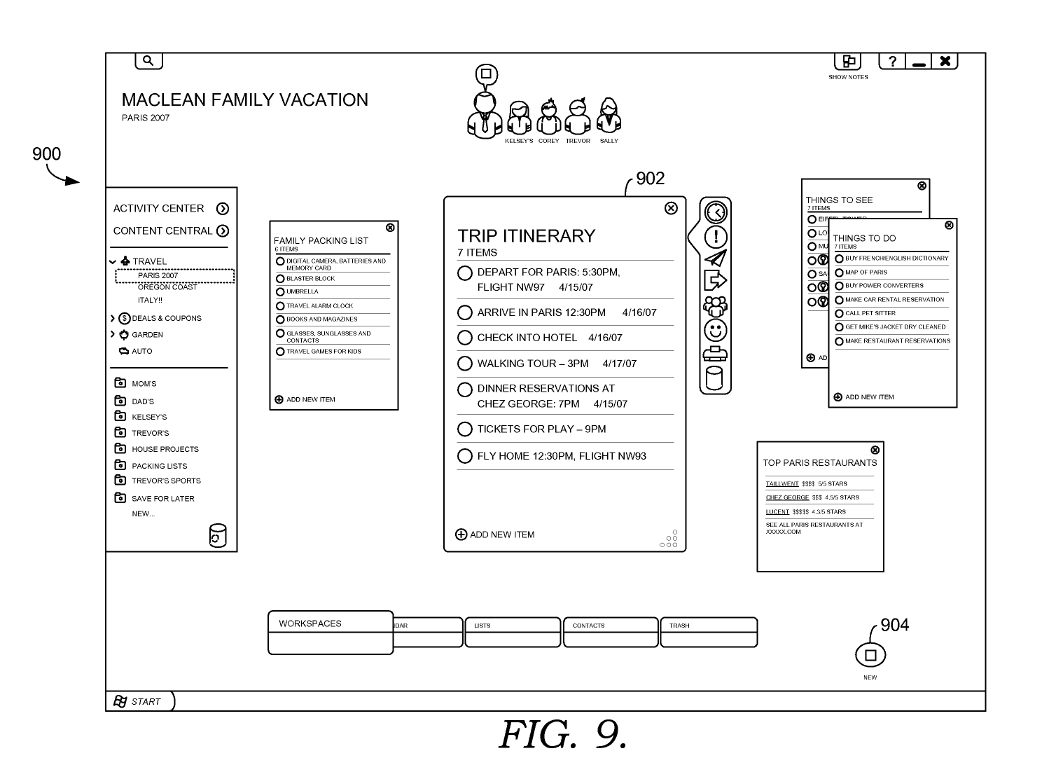

After Dad opens “Paris 2007” contextual computer workspace 700, he may modify the contextual computer workspace 700. In particular, Dad adds a new window view 802 of FIG. 8 that he desires to include in the “Paris 2007” contextual computer workspace 800. Upon adding the new window view 802, Dad may add content to the window view as demonstrated by window view 902 of FIG. 9. Dad may choose to arrange the window views or modify content within any displayed window view.

Suppose again that Dad has, for the time being, finished modifying the contextual computer workspace. This time, rather than closing the “Paris 2007” contextual computer workspace 900, Dad chooses to begin a new workspace by selecting the “New” icon 904. Dad's selection of the “New” icon 904, in this case, provides an indication to capture the current state of the contextual computer workstation 900. In one embodiment, the current state of the contextual computer workstation 900 will replace the prior first state of the contextual computer workstation 600 captured in FIG. 6 such that when Dad later returns to the contextual computer workspace, he will view ‘Paris 2007” contextual computer workspace 900. Alternatively, the new state of the contextual computer workspace 900 may be captured in addition to the prior state of the contextual computer workstation such that, at a later instance, Dad may choose the state he prefers to view and modify, e.g., the first state captured in FIG. 6 or the second state captured in FIG. 9.

In one embodiment, multiple users may view and manipulate the windows and content thereof within a contextual computer workspace. In such a case, although one user may capture a state of a contextual computer workspace, another user may, at a later time, select the contextual computer workspace to view and manipulate the contextual computer workspace. By way of example only, with reference to FIGS. 6 and 7, Dad may capture the state of the contextual computer workspace 600 as displayed in FIG. 6. At a later instance, Sally may select the “Paris 2007” contextual computer workspace 702 listed within the workspace selection tool 704 of contextual computer workspace 700 of FIG. 7. The first state of the contextual computer workspace 600 captured by Dad in FIG. 6 is restored and output such that Sally may view and modify the “Paris 2007” contextual computer workspace, as displayed by “Paris 2007” contextual computer workspace 700 in FIG. 7. After Sally opens “Paris 2007” contextual computer workspace 700, she may modify the contextual computer workspace 700.

From the foregoing, it will be seen that this invention is one well adapted to attain all the ends and objects set forth above, together with other advantages which are obvious and inherent to the methods, computer-readable media, and graphical user interfaces. It will be understood that certain features and subcombinations are of utility and may be employed without reference to other features and subcombinations. This is contemplated by and is within the scope of the claims.

The invention claimed is:

1. In a computer system having a graphical user interface including a display and a user interface selection device, a method for capturing and outputting at least one state of at least one contextual computer workspace, the method comprising:
receiving an indication to capture the at least one state of the at least one contextual computer workspace at a first instance, wherein the at least one contextual computer workspace comprises at least one window view;
identifying one or more of the at least one window view to capture in the at least one state of the at least one contextual computer workspace;
retrieving information pertaining to the one or more of the at least one identified window view;
storing the retrieved information to capture the at least one state of the at least one contextual computer workspace;
receiving, at a second instance, an indication to output the at least one contextual computer workspace having the state of the contextual computer workspace at the first instance; and
outputting the at least one contextual computer workspace having the state of the contextual computer workspace at the first instance, wherein at least one user may view and interact with the contextual computer workspace.

2. The method of claim 1, wherein the indication to capture the at least one state of the at least one contextual computer workspace is received upon the at least one user's selection to close the at least one contextual computer workspace, to close an application, to create a workspace, to log off an application, to log off an operating system, to capture the at least one state of the at least one contextual computer workspace, or to open another contextual computer workspace.

3. The method of claim 1, wherein the at least one window view to capture in the at least one state of the at least one contextual computer workspace comprises all open window views, window views specified by the at least one user, or all open window views with the exception of general window views.

4. The method of claim 1, wherein the information retrieved comprises the location of the at least one window view, the position of the at least one window view, the size of the at least one window view, the vertical order, the specific state of the at least one window view, or a combination thereof.

5. The method of claim 4, wherein the size of the at least one window view comprises a percentage of a screen resolution.

6. The method of claim 1, wherein the information is stored in a database.

7. The method of claim 1, wherein the indication to output the at least one contextual computer workspace at a second instance is received upon the at least one user's selection to open the at least one contextual computer workspace, to open the at least one state of the at least one contextual computer workspace, or to log on to an application, web-based application, or operating system.

8. The method of claim 1, wherein the at least one contextual computer workspace output further comprises an advertisement from an advertiser.

9. The method of claim 8, wherein the advertisement relates to the at least one contextual computer workspace.

10. The method of claim 1, wherein the stored information is associated with an identifier.

11. A method in a computer system for outputting a state of a contextual computer workspace, the method comprising:
storing information retrieved from one or more window views having a first state of a contextual computer workspace, wherein the contextual computer workspace comprises one or more window views;
receiving an indication to access the contextual computer workspace; and
outputting the contextual computer workspace having a restored state that is substantially similar to the first state of the contextual computer workspace.

12. The method of claim 11, wherein the indication to access the contextual computer workspace is received upon at least one user's selection to open the contextual computer workspace via a workspace selection tool.

13. The method of claim 12, wherein the workspace selection tool comprises a list of contextual computer workspace names, tabs of contextual computer workspaces, icons indicating contextual computer workspaces, thumbnails displaying contextual computer workspace images, or a combination thereof.

14. A computer system for capturing a first state of a contextual computer workspace comprising:
an identifying component to identify at least one open window view;
a retrieving component to retrieve information pertaining to one or more of the at least one open window view identified by identifying component; and
a storing component to store the information retrieved by the retrieving component.

15. The computer system of claim 14 further comprising a capturing component configured to receive an indication to capture the first state of the contextual computer workspace.

16. The computer system of claim 15, wherein the indication to capture the first state of the contextual computer workspace is provided by at least one user.

17. The computer system of claim 14, further comprising a determining component configured to determine one or more of the at least one window views to include in the first state of the contextual computer workspace.

18. The computer system of claim 14 further comprising:
a receiving component configured to receive an indication to access the contextual computer workspace;
a restoring component configured to restore a state of the contextual computer workspace so that the restored state of the outputted contextual computer workspace will be substantially similar to the first state of the contextual computer workspace; and
an outputting component configured to output the restored state of the contextual computer workspace.

19. The computer system of claim 18, wherein the outputting component outputs the contextual computer workspace having an advertisement.

20. The computer system of claim 19, wherein the advertisement comprises a contextual advertisement.
